(19) United States
(12) Patent Application Publication
(10) Pub. No.: US 2016/0238213 A1
(43) Pub. Date: Aug. 18, 2016

(54) Frame and Removable Lampshade

(71) Applicant: Shade-a-Delic, LLC, Maryville, TN (US)

(72) Inventor: Mark A. Kimmet, Knoxville, TN (US)

(73) Assignee: Shade-a-Delic, LLC, Maryville, TN (US)

(21) Appl. No.: 15/017,684

(22) Filed: Feb. 8, 2016

Related U.S. Application Data
(60) Provisional application No. 62/115,181, filed on Feb. 12, 2015.

(51) Int. Cl. F21V 1/14; F21V 1/04

(52) U.S. Cl. CPC F21V 1/143; F21V 1/04

(57) ABSTRACT

A lampshade includes a frame having a shape that forms a plurality of windows. A shade fits within the frame mounted on projections extending from the frame. Apertures in the shade receive the projections, and covers are resiliently affixed to the projections to capture the shade on the projections. A spider mounts the frame to an electric lamp. The spider includes a hub that attaches to an electric lamp and a plurality of arms that are attached to the inside of the lampshade frame. In this configuration the covers, the spider and the shade are easily removed and replaced. Images are formed on the shade and are positioned to be displayed in the windows of the frame such that the windows act as picture frames.

### CROSS-REFERENCE TO RELATED APPLICATION

The present application claims priority to provisional application No. 62/115,181, filed Feb. 12, 2015, entitled Frame and Removable Lampshade, naming the inventor as: Mark A. Kimmet

### FIELD

The present invention relates to the field of lampshades and particularly relates to a lampshade having a frame and an easily removable shade.

### BACKGROUND

Lampshades are typically constructed on a wire frame with a cloth shade. In general, the shade is not intended to be separated from the frame. Of course, it is possible to separate the shade and replace the shade, but it is generally difficult and not frequently done. Even in lampshades that have been designed for easy removal of the shade, the process remains cumbersome. In the embodiments described herein the deficiencies of prior lampshades have been overcome by providing a lampshade that has a sturdy attractive frame and the shade itself is designed for easy convenient attachment and removal.

In one embodiment, the lampshade includes a frame and a shade. The frame has a generally cylindrical shape and includes upper and lower cylindrical flanges. A plurality of middle flanges extend between the upper and lower cylindrical flanges, and the plurality of windows are formed by the flanges. A plurality of projections extend inwardly from the lamp shade frame for holding the shade. The shade is dimensioned to fit within the generally cylindrical shape of the frame. The shade includes apertures that are dimensioned to snuggly receive or fit over each of the plurality of projections on the interior of the frame. The apertures on the shade are positioned such that the shade will fit completely within the lampshade frame and cover the plurality of windows. Thus, the apertures in the shade are mounted on the projections to securely hold the shade within the frame. A plurality of covers are configured for releasably attaching to the plurality of projections after the shade is mounted thereon. Thus, the covers may be used to hold or capture the shade on the projections within the frame and thereby secure the shade within the frame.

To mount the lampshade on an electric lamp, a spider is provided. The spider is preferably constructed with arms made of a resilient flexible material such as a metal wire, and the arms extend outwardly from a central hub. The configuration of the hub is designed to fit on an electric lamp and it will vary from this configuration depending upon the type of electric lamp on which the lampshade is being mounted. In most configurations, the hub is constructed of stamped metal, but any material of suitable strength and heat resistance may be used for the hub. The spider is held in position within the frame by the resiliency of the frame and the resiliency of the spider itself. Preferably, hoops are formed on the outside ends of the arms distal from the hub. The hoops are dimensioned to fit relatively snuggly over the covers on the projections. To mount the spider within the frame, the arms of the spider must be flexed inwardly so that they fit over the covers. At the same time that the spider arms are flexed, the frame itself may be flexed to allow the hoops to be positioned over the covers. Once the hoops are properly positioned, the arms and the frame will return to a non-flexed position to the extent possible with the hoops sliding over the covers in an outward direction. The resiliency of both the arms and the frame hold the spiders in place on the lampshade.

In this configuration, the spider may be easily attached and removed from the lampshade and similarly the covers may be quickly removed from the projections so that the shade can be removed and replaced with another shade of the same dimensions and configuration. Thus, the lampshade will accommodate numerous different shades and the shades may be easily replaced if desired. In one embodiment, a plurality of images are printed or otherwise formed on the shade. The number of images is equal to the number of windows in the lampshade frame, and the images are disposed on the shade so that each image will be positioned at least partially within a window when the shade is mounted in the frame. Thus, the lampshade frame may function as a plurality of picture frames displaying a plurality of images. In alternate embodiments at least one image may be formed on the shade and the image may be positioned at least partially in at least one window when the shade is mounted the frame. In this embodiment an image may overlap the windows and appear in more than one window.

### BRIEF DESCRIPTION OF THE DRAWINGS

Further advantages of the invention are apparent by reference to the detailed description when considered in conjunction with the FIGS., which are not to scale so as to more clearly show the details, wherein like reference numbers indicate like elements throughout the several views, and wherein:

FIG. 1 is a perspective view of a sheet metal blank used to construct a lampshade frame for holding replaceable shades;

FIG. 2 Is a perspective view of the sheet metal blank after processing to create curvature in the blank;

FIG. 3 is a plan view of a lamp shade held by the lampshade frame;

FIG. 4 is a plan view of a shade showing multiple images on the shade for being displayed and held by the lampshade frame;

FIG. 5 is a perspective view of the lampshade frame after it has been assembled into its final configuration;

FIG. 6 is a detailed view of a screw and cylindrical nut holding the opposite ends of the lampshade frame together to form a frame having a cylindrical configuration;

FIG. 7 is a disassembled view of the screw and nut shown in FIG. 6.

FIG. 8 is a rubber cover that is mounted on the nut within the assembled lampshade frame;

FIG. 9 is a is a perspective illustration of a shade being manually inserted into an assembled lampshade frame;

FIG. 10 is a perspective view of a shade mounted within the lampshade frame and held on the cylindrical nuts;

FIG. 11 is a perspective view of a spider that is mounted within the assembled frame;

FIG. 12 is a perspective view of the shade and lampshade frame assembled with a spider mounted thereon held in place by the spring force of the frame and spider;

FIG. 13 is a front perspective view of the assembled lampshade and frame;

FIG. 14 a back perspective view of the lampshade and frame;

FIGS. 15, 16 and 17 are top, side and front views of a spider that may be used in the assembled lampshade frame;

FIGS. 18, 19 and 20 are top, side and front views of another spider that may be used in the assembled lampshade and frame;

FIG. 21 is a plan view of a metal blank for use in making a lampshade frame;

FIG. 22 is a plan view of another metal blank for use in making a lampshade frame;

FIG. 23 is a perspective of a tall slender lamp shade frame having rectangular panels;

FIG. 24 is a perspective view of a short lamp shade frame having square panels;

FIG. 25 is a plan view of a blank 98 used to construct the lampshade frame of FIG. 23;

FIG. 26 is a plan view of a blank 100 used to construct the lampshade frame of FIG. 24

FIG. 27 is a perspective view of a frustro-conically shaped lamp shade frame having a circular cross-section;

FIG. 28 is a plan view of a blank used to construct the lamp shade frame of FIG. 27;

FIG. 29 is a perspective view of a frustro-conically shaped lamp shade frame having a square cross-section; and

FIG. 30 is a plan view of a blank used to construct a frame of FIG. 29.

### DETAILED DESCRIPTION

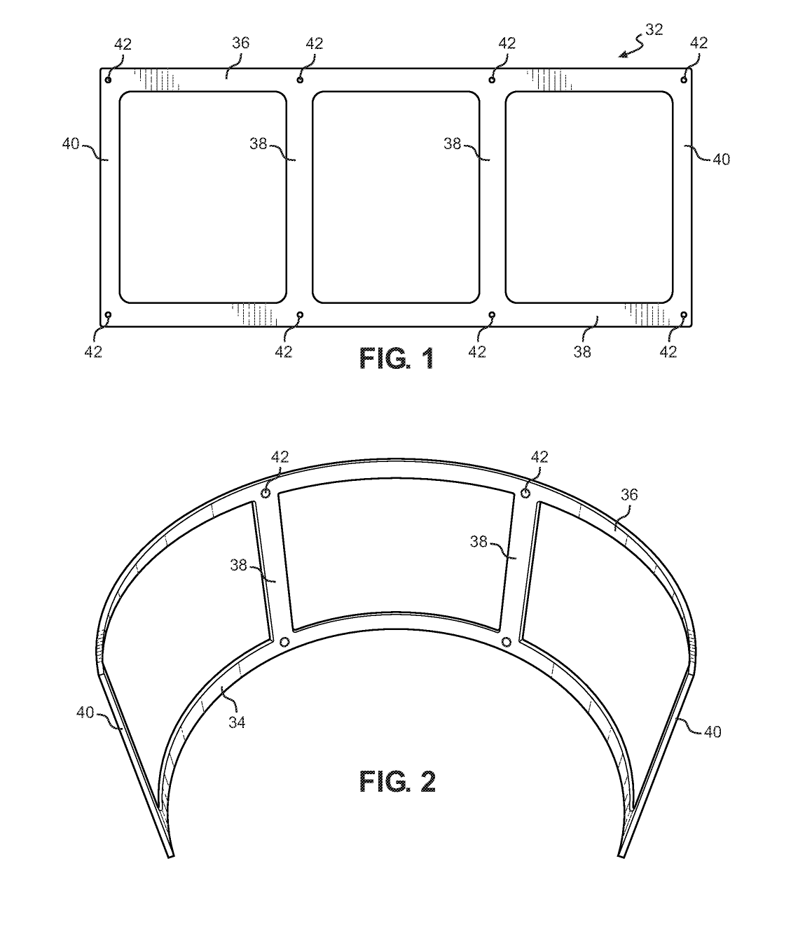

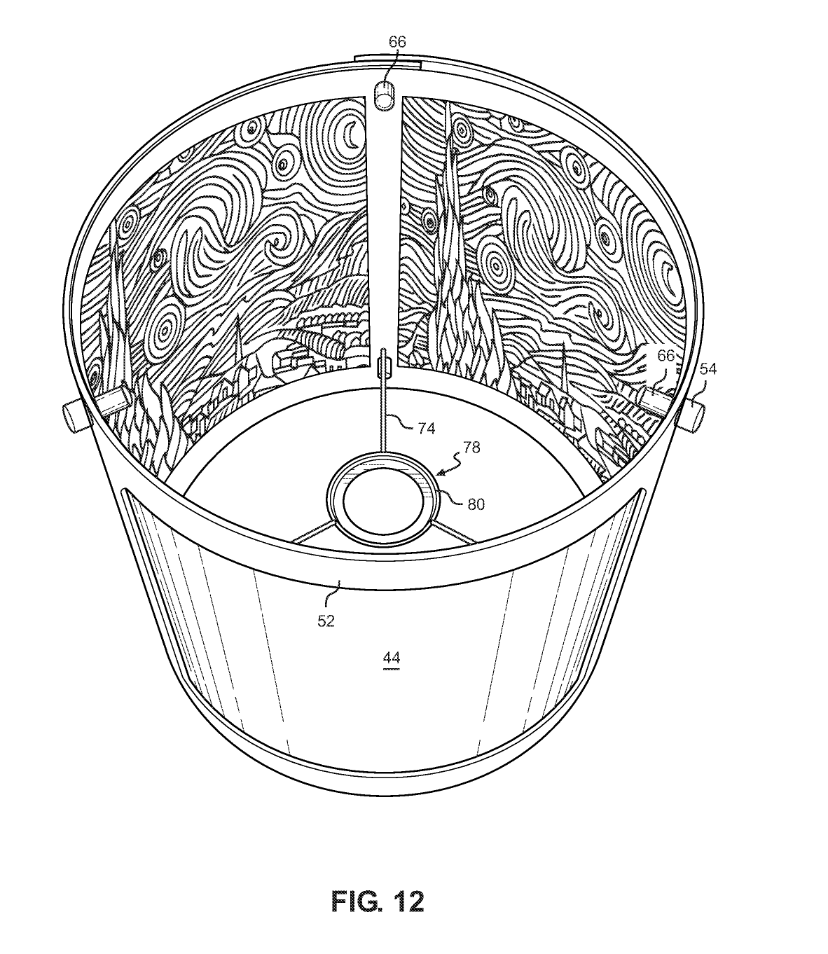

Referring now to the drawings in which like reference characters to designate like or corresponding parts throughout the several views, there is shown in FIG. 1 a metal blank 32 that is used to construct a frame 52 for holding a lampshade 44, both of which are best shown in FIG. 12. The blank 32 is originally constructed with a flat or planar configuration and may be stamped from a metal sheet such as an aluminum sheet. Alternatively, it could be constructed from a resilient strong polymer, such as nylon, PVC or polypropylene; or a cellulose based material, such as bamboo, wood or paper; or a resin based product such as fiberglass or carbon fiber. The blank 32 includes a lower horizontal flange 34 and an upper horizontal flange 36. Extending between the upper and lower flanges 34 and 36 are two vertical middle flanges 38 and two vertical and flanges 40. In this configuration the blank 32 forms a thin-walled beam structure suitable for assembly into the lampshade frame 52 (FIG. 12). The blank further includes a plurality of apertures 42 that are spaced apart along the lower flange 34 and the upper flange 36. The apertures 34 are dimensioned to receive hardware for holding the blank 32 in the shape of the frame 52 and for holding the shade 44 in the frame as will hereinafter be described.

As a first step in forming the lampshade, the metal blank 32 may be cold rolled to place a slight continuous bend into the blank 32 such that it adopts the configuration shown in FIG. 2. In this configuration, the outer surface of the blank 32 stretched or tensioned and the inner surface is relatively compressed. Thus, the blank is predisposed to adopt a cylindrical shape during later assembly.

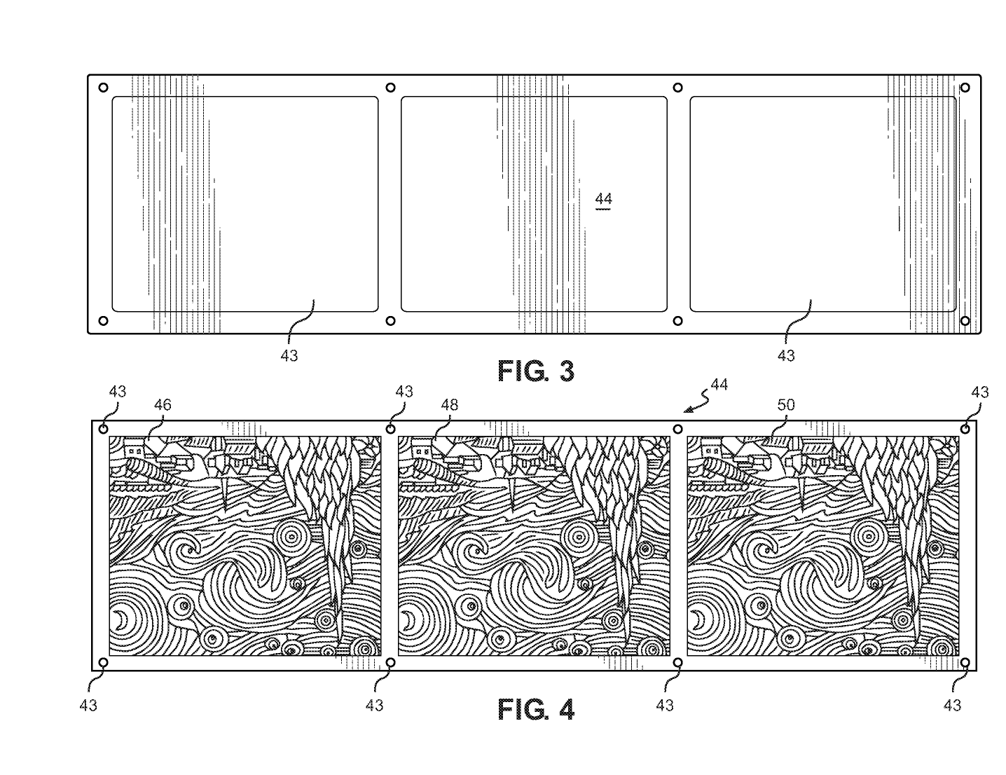

Referring now to FIG. 3, there is shown a shade 44 that has a rectangular configuration that will precisely match the shape of the blank 32. The shade 44 may have slightly smaller exterior dimensions such that it will fit within the overall dimensions of the blank 32. Apertures 43 formed in the shade 44 spaced apart along the upper and lower edges of the state 44. The apertures 43 are positioned in the shade 44 such that they will precisely align with the apertures 42 in the blank 32 when the blank is curved into a cylindrical shape.

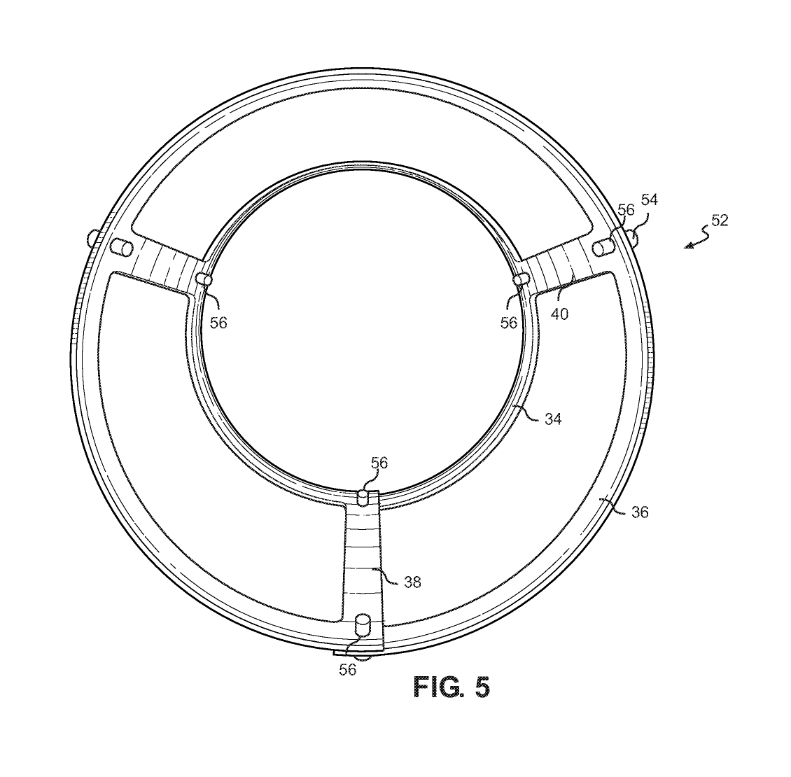

Referring to FIG. 4, the opposite side of the shade 44 is shown, which is normally the exterior side of the shade. In this view, it is seen that the shade 44 includes three images 46, 48 and 50 that are dimensioned to be viewed when the shade 44 is mounted in the frame 52. In FIG. 5 a top perspective view of an assembled lampshade frame 52 is shown. To form a generally cylindrical lampshade frame 52 the upper and lower horizontal Flanges 34 and 36 have been curved and placed into tension until they form a cylinder shape. The two end flanges 40 precisely overlap each other, and the apertures 42 are aligned to such that the two end flanges 40 may be secured together by screws 54 and nuts 56 that are positioned and secured through the apertures 42. The two end flanges 40 are secured together by two screws 54 and nuts 56. In this cylindrical configuration, three windows 60, 62 and 64 are created within the lampshade frame 52. The vertical margins of the windows are defined by the two middle vertical flanges 38 and by the two end flanges 40. The horizontal margins of the windows 60, 62 and 64 are defined by the upper and lower horizontal flanges 36 and 38. The images 46, 48 and 50 are dimensioned and positioned to be framed by the windows 60, 62 and 64, and the apertures 43 and 44 are configured to ensure that the images are properly positioned within the windows.

While FIG. 4 displays three identical images 46, 48 and 50, it will be understood that the images may be different if desired. For example, the lampshade 44 may be constructed with personal images printed on the shade. Or example, different wedding pictures or engagement pictures could be printed on the shade and displayed at a wedding reception. Every lamp at the reception could have three different pictures such that tens or even hundreds of pictures could be displayed. When the lampshade 44 is used at home, the lampshade could be replaced periodically to change the appearance of a lamp. For example, the pictures 46, 48 and 50 could be different seasonal pictures and the lampshade 44 could be changed with the four seasons.

The lampshade 44 may be constructed of a white translucent material such as a polymer sheet or cloth. The material is chosen such that it may be printed on easily to create a substantially permanent set of images 46, 48 and 50. The material may also be heat resistant and flame resistant. In alternate embodiments the material may be laminated. For example, the interior laminate may be a paper or cloth specifically designed for printing images. The interior and exterior laminates may be transparent films designed to protect the image from abrasion, heat and oxygen. If desired, a transparent material may be used for the lampshade 44, such as a transparent film. With both transparent and translucent lampshades 44 the image may be printed with an image (including graphics and designs) to completely cover or partially cover the windows 60, 62 and 64.

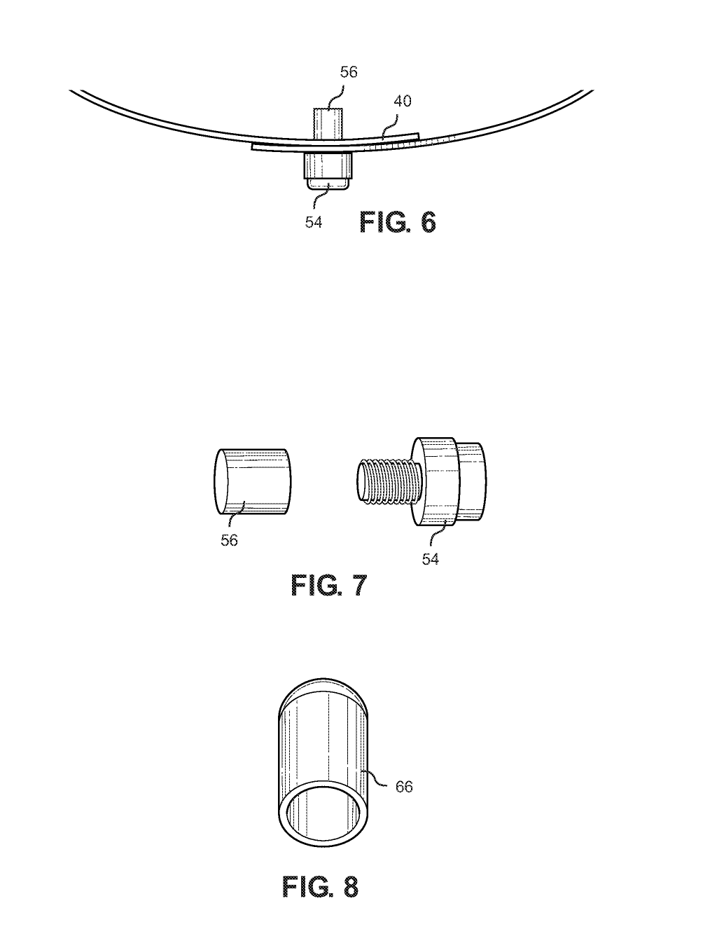

Detailed views of the hardware used in constructing the frame 52 are shown in FIGS. 6 and 7. As best shown in FIG. 7, the threaded nut 56 has a cylindrical exterior as does the head of screw 54. The screw 54 is inserted through the apertures 42 and the nut 56 is used to secure the screws 54 in the apertures 42. As best shown in FIG. 5, two screws 54 are used to secure the end flanges 40 together and four additional screws 54 and nuts 56 are secured in the lampshade in positions immediately above and below the middle vertical flanges 38. The diameter of the cylindrical nut 56 is slightly smaller than the diameter of the apertures 43 such that the six nuts 56 on the interior of the frame may be snuggly positioned within the apertures 43 when the shade 44 is mounted within the frame 52.

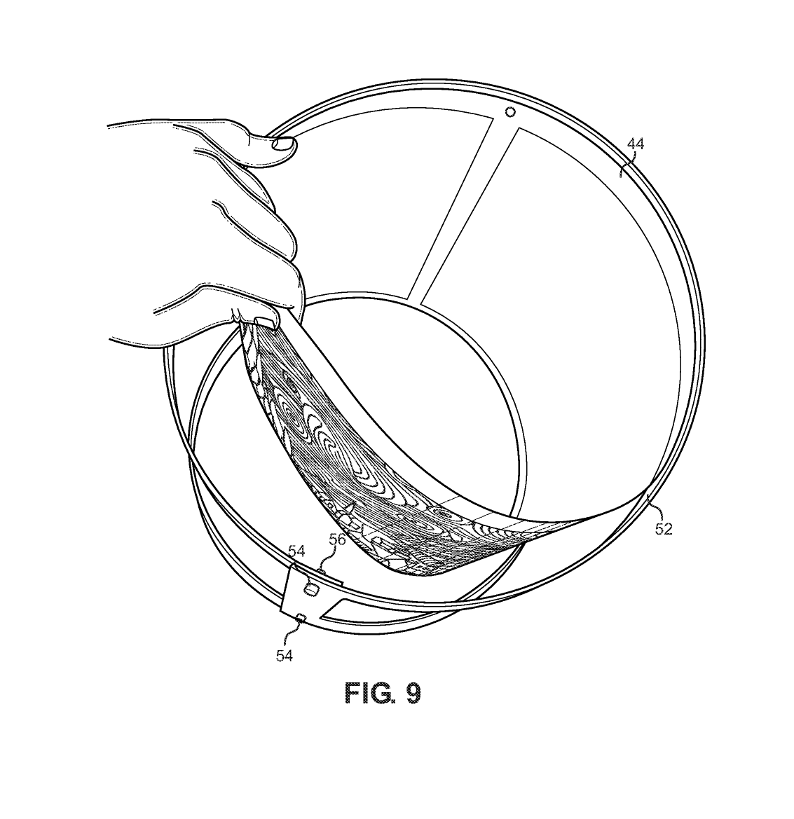

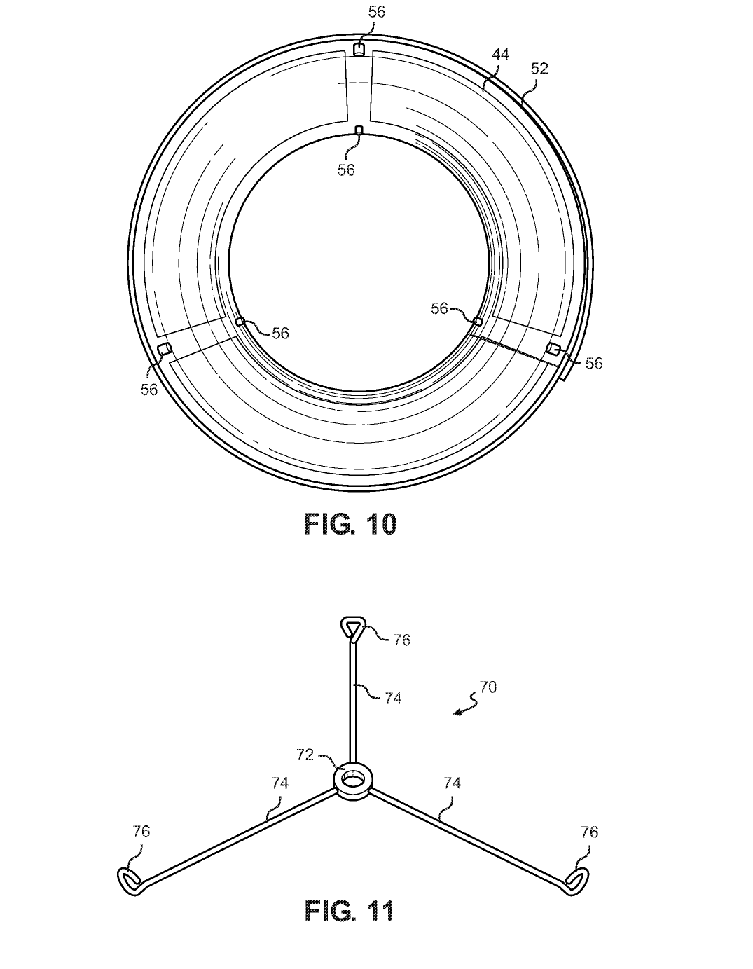

The assembly of the shade 44 within the frame 52 is best illustrated in FIGS. 9 and 10. To install the shade 44, it is first coiled into a cylindrical shape having a diameter smaller than the frame 52, and the shade 44 is inserted into the frame 52 is shown in FIG. 9. Then, the apertures 43 are aligned with and positioned on the nuts 56. In this embodiment the shade has a stiffness and a resiliency that will tend to hold the shade 44 on the nuts 56. In other words, the resiliency of the shade 44 will cause it to uncoil and expand outwardly such that it captures itself on the nuts 56. To further secure the shade 44 in place, rubber covers 66 are positioned on the exposed nuts 56. The rubber covers 66 are resilient, slightly tacky and dimensioned to snuggly fit on the outside of the nuts 56. When the covers 66 are placed on the nuts 56, the shade 44 is captured in a desired position within the frame 42 on the nuts 56.

Referring to FIG. 11, a spider 70 is illustrated. The spider 70 is used to mount the lampshade onto a conventional electric lamp. Numerous different types of spider configurations are used in the lamp industry, and all of the configurations can be adapted for use in combination with the lampshade of the present invention. The spider 70 includes a central hub 72 that is used to mount the spider 72 and electric lamp. Three arms 74 extend outwardly from the hub 72 and are spaced apart by a 120°. Hoops 76 are formed on the outside ends the arms 74 and the hoops 76 are dimensioned to snuggly fit over the rubber covers 66. To install the spider 70, two of the hoops 76 are inserted over the rubber covers 66 mounted on the nuts 56. The first two hoops 76 may be properly positioned over the covers 66 with only a slight bending or flexing of the arms 74. However, the spider 70 is dimensioned such that the positioning of the third hoop 76 requires significant flexing of both the arm 74 and the frame 52. Both are designed of resilient materials that will flex to allow proper positioning of the hoop. Once the third hoop 76 is assembled over the nut 56, the spider is held in position by the spring resiliency of both the spider 70 and the frame 52.

A perspective view of an assembled frame 52 and shade 44 is shown in FIG. 12. In this view, the shade 44 has been mounted inside-out, meaning the images on the lampshade 44 are facing in when they would normally face out. This assembly was chosen to increase contrast for illustration purposes. Also, by viewing the images 46, 48 and 50 inside the frame 52, it is clear that the images (when facing outwardly) will be positioned to fit over and cover the windows 60, 62 and 64. In this view, the rubber covers 66 are positioned on the nuts 56 to hold the shade 44 in position on the frame 52. In FIG. 12, a spider 78 is mounted within the frame 52 in the manner described above. This particular spider 78 differs slightly from the spider 70 described above in that a different type of hub 80 is used. This different hub 80 is designed to fit a different type of conventional electrical lamp. However, otherwise the spider is configured similarly with flexible resilient arms 74 extending outwardly from the hub 80. The arms 74 extend outwardly and terminate at hoops similar to hoops 76 disclosed in FIG. 11. Such hoops are positioned over the rubber covers 66 to mount the spider 78 within the frame 52.

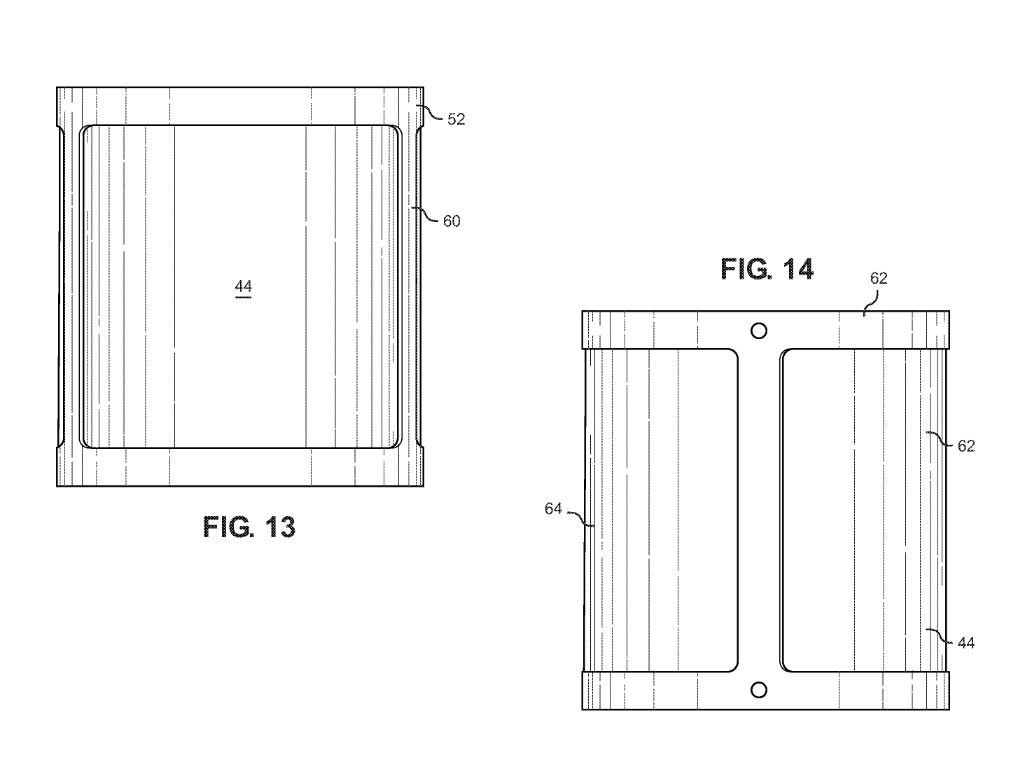

A front view of the assembled frame 52 and shade 44 is shown in FIG. 13 and a back view of the frame 52 and shade 44 is shown in FIG. 14. In these two views, it may be appreciated that the frame 52 creates three windows 60, 62 and 64 that appear almost as picture frames surrounding a portion of the shade 44. In these FIGS., the shade 44 is shown inside out and thus only a translucent white shade material is visible through the three windows. However, it will be appreciated that any three images could be printed on the lampshade so that the images appear in the windows 60, 62 and 64. Thus, when the lampshade is mounted on an electric lamp, the images would be illuminated from within and would appear as back lighted picture images. Even when placed in the shade inside out, the images would be partially visible through a translucent shade, and it may be desirable to place certain images on the interior of the frame 52 to create an effect on the appearance of the images.

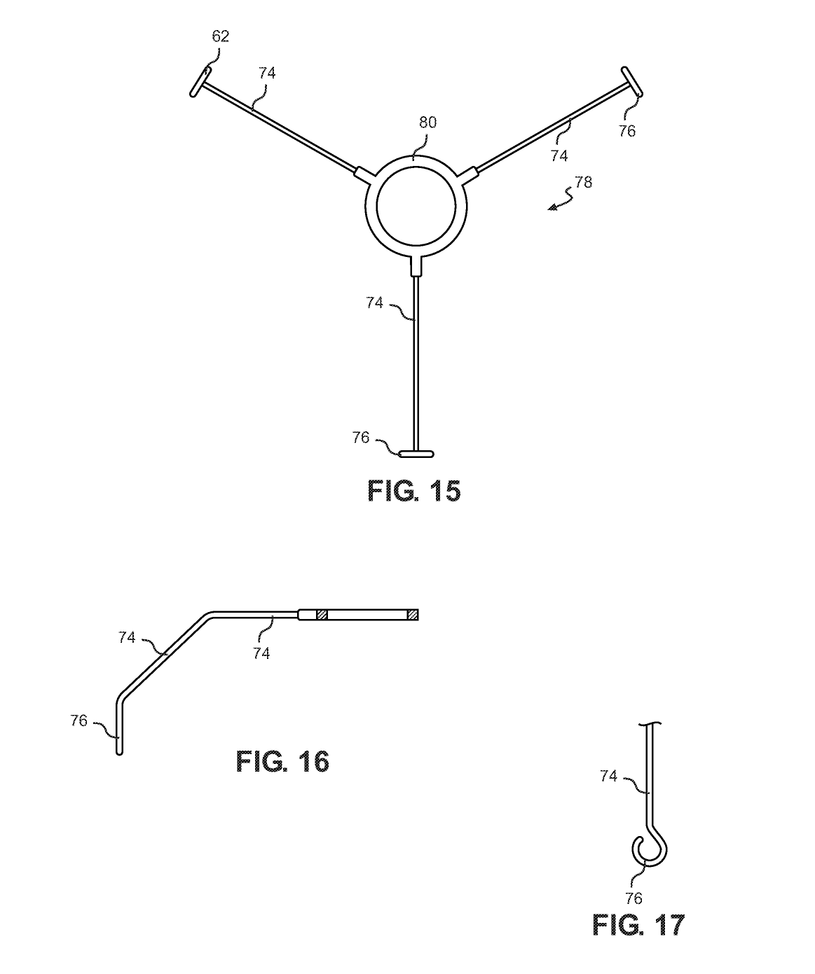

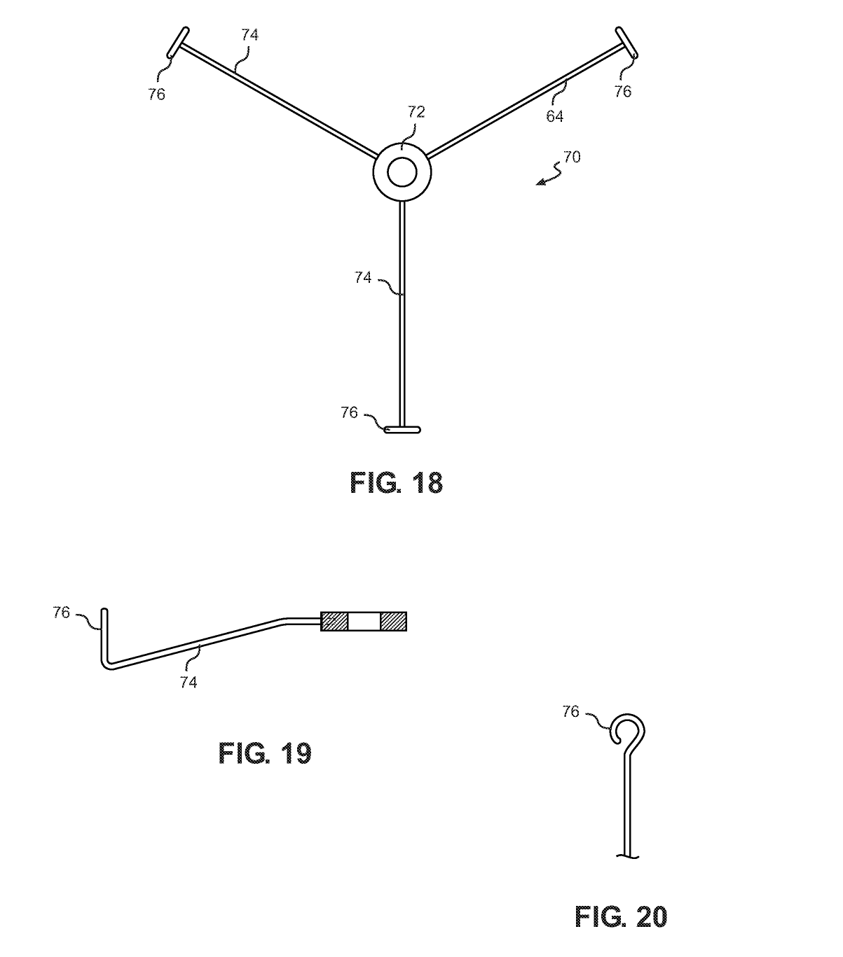

FIGS. 15, 16 and 17 illustrate top, side and loop front views of the spider 78 shown in FIG. 12. Likewise, FIGS. 18, 19 and 20 illustrate top, side and loop front views of spider 70 shown in FIG. 11. By comparing these various views, it will be appreciated that the spiders differ slightly so as to accommodate different types of conventional electric lamps. However, they function similarly in that they are held in place by hoops 76 that are mounted on the rubber covers 66 within the lampshade frame 52. The resiliency of the spiders 70 and 78 create spring force that will hold the spiders 70 and 78 in place within the frame 52. Thus, a spider of this general construction may be modified in minor ways to fit any conventional lamp.

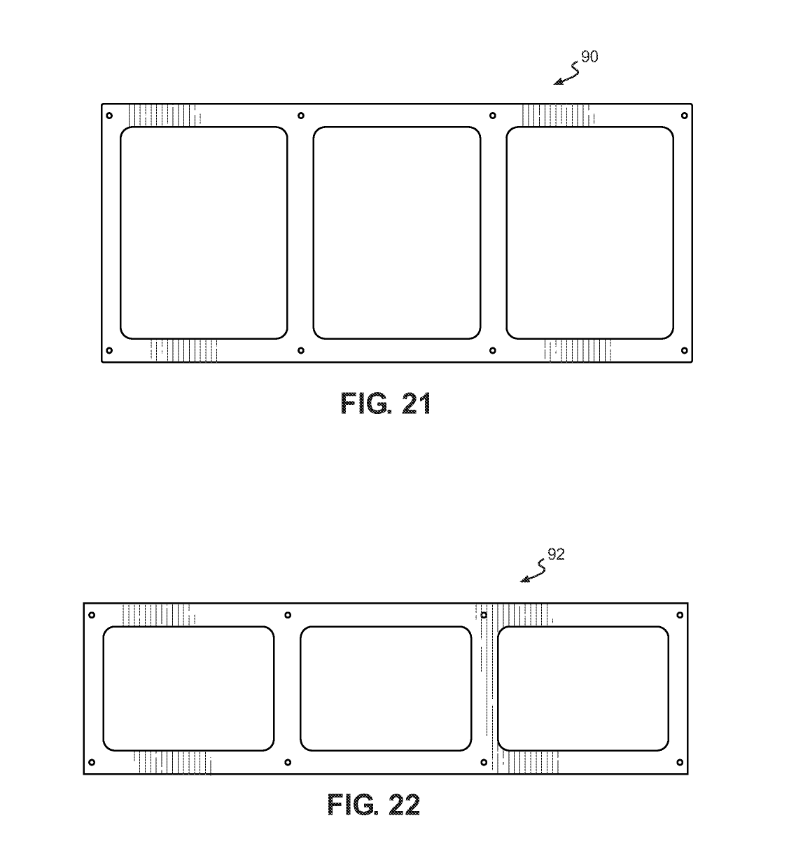

FIGS. 21 and 22 illustrate lamp shade blanks 90 and 92 similar to the blank 32 shown in FIG. 1. As illustrated by the blanks 90 and 92, the lampshade frame 52 may have many different dimensions such that the windows created by the frames may appear to be square, landscape rectangles, or portrait rectangles.

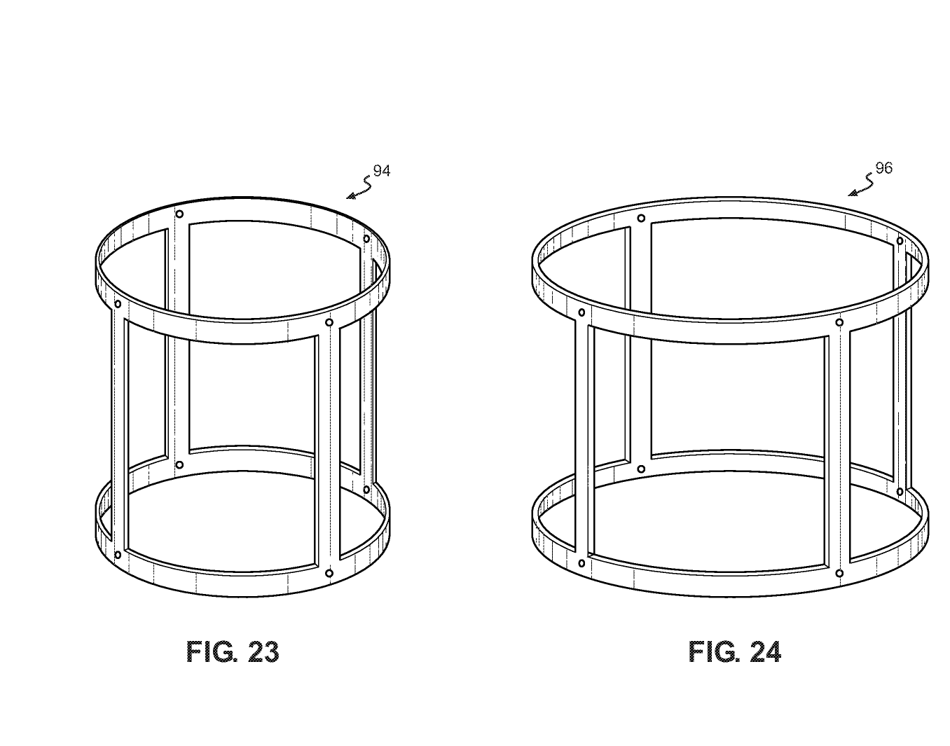

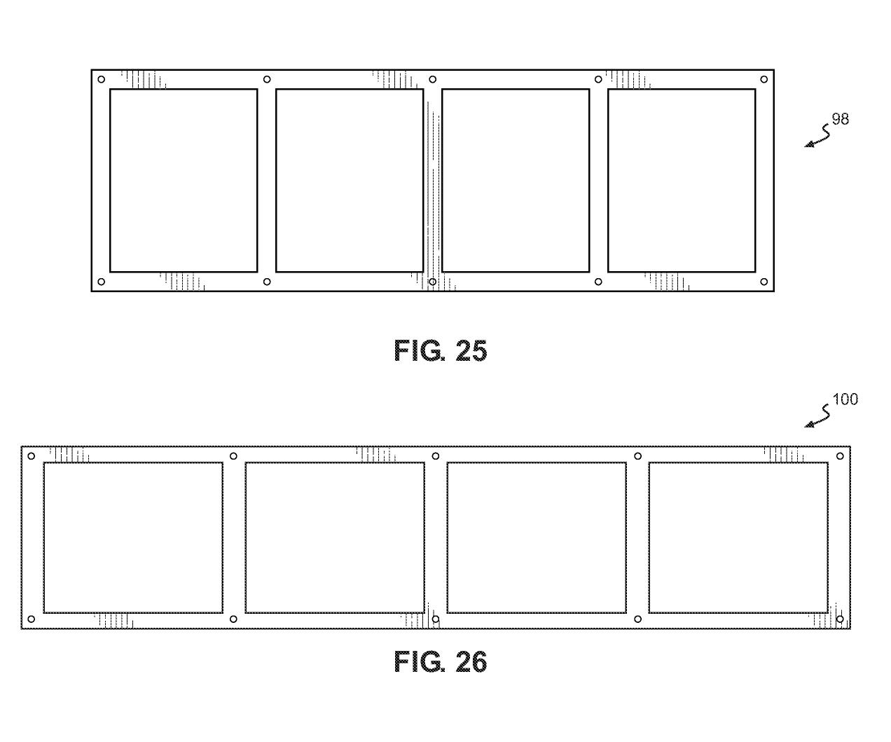

FIGS. 23 and 24 illustrate lamp shade frames 94 and 96 having circular cross-sections and rectangular openings or panels. These figures illustrate that the circular diameters and height of the lampshade may assume various dimensions. FIGS. 25 and 26 illustrate blanks 98 and 100 that are used to construct the frames 94 and 96 respectively.

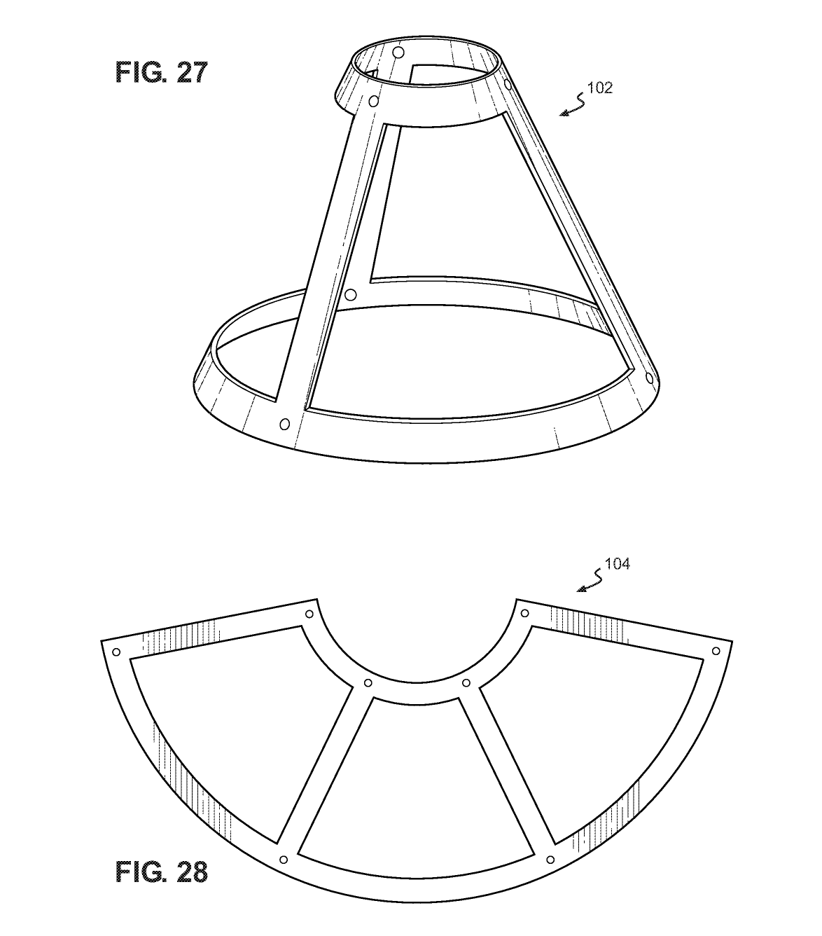

FIG. 27 illustrates a lamp shade frame 102 having a frustoconical shape and a circular cross-section. In this particular embodiment, the frame 102 is constructed with three openings or panels through which the lamp shade is viewable.

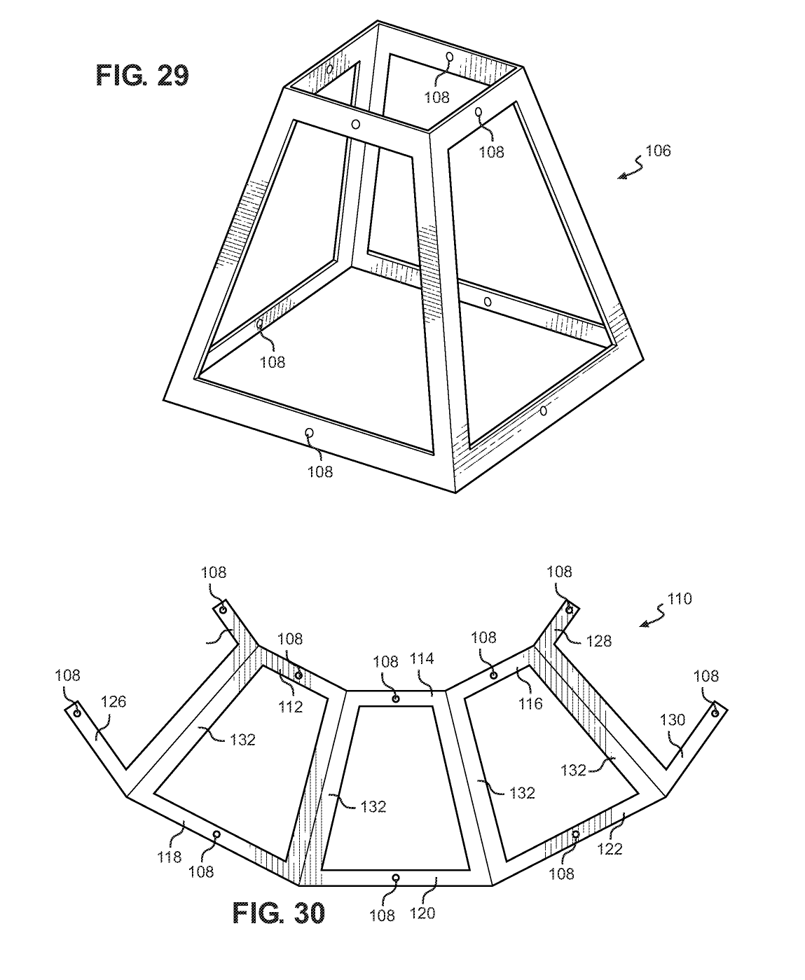

FIG. 29 illustrates a lamp shade frame 106 having a frustoconical shape and a square cross-section. This particular embodiment illustrates that the lamp shade frame of the present invention may not have a circular cross-section. In this particular embodiment, the cross-section is square, but the cross-section could also be in the shape of any polygon, such as a triangle, a pentagon, a hexagon, etc. This particular embodiment also illustrates that the apertures 108 in the frame 106 may be placed in the mid region of the horizontal flanges and need not be placed above and below the vertical flanges.

Referring to FIG. 30, a plan view of a blank 110 used to construct the frame 106 is shown. In this view, it may be appreciated that the apertures 108 are formed in the mid regions of lower horizontal flanges 118, 120 and 122. Likewise, apertures 108 are formed in the mid regions of the upper horizontal flanges 112, 114 and 116. These apertures are designed to receive hardware, such as the bolts described above, that in turn secure a lampshade to the frame 106.

Apertures 108 are also formed adjacent the ends of lower horizontal flanges 126 and 130. Likewise, apertures 108 are formed adjacent the ends of upper horizontal flanges 124 and 128. When the blank 110 is assembled into the frame 106, the vertical flanges of the blank 110 are bent approximately 90° along crease lines 132 forming the frustoconical shape shown in FIG. 29. In that configuration, flange 124 overlaps flange 128 and flange 126 overlaps flange 130 with the apertures 108 in the ends of the flanges being aligned. Thus, a nut and bolt may be used to secure flange 124 to flange 128 and flange 126 to flange 130. When secured together, flanges 126 and 130 form a single horizontal flange in the frame 106. Likewise flanges 124 and 128 form a single upper horizontal flange in the frame 106.

From the above discussion of different embodiments and variations, it will be appreciated that the invention is capable of numerous rearrangements, modifications and and substitutions of parts without departing from the scope of the invention as defined by the appended claims. The embodiments described herein are intended as examples and should not be construed as limitations.

What is claimed is:

1. A lampshade for an electric lamp comprising:
a lampshade frame having a generally elliptical shape and including an upper elliptical flange, a lower elliptical flange and a plurality of middle flanges extending between the upper and lower elliptical flange, a plurality of windows being formed by the upper flange, lower flange and middle flanges;
a plurality of projections extending inwardly from the lampshade frame;
a shade dimensioned to fit within the generally elliptical shape of the lamp shade frame and having apertures dimensioned to snuggly receive each of the plurality of projections, the apertures being positioned such that the shade fits within the lampshade frame and covers the plurality of windows when the apertures are mounted on the projections;
a plurality of covers configured to releasably attach to the plurality of projections when the shade is mounted on the projections and to thereby capture the shade on the projections within the lampshade frame; and
a spider having a plurality of arms releasably attached to the inside of the lampshade frame and having a hub attached to the arms, the hub being configured for mounting the lampshade on the electric lamp; and
the covers and the spider being configured for easy removal from the lampshade frame so that the shade can be easily removed and replaced with another shade of the same dimensions and configuration.

2. The lampshade of claim 1 further comprising a plurality of images formed on the shade, the number of images being equal to the number of windows in the lampshade frame, the images being disposed on the shade so that each image is positioned at least partially within a window when the shade is mounted in the lampshade frame.

3. The lampshade of claim 1 further comprising at least one image formed on the shade, the image being disposed on the shade so that the image is positioned at least partially in at least one window when the shade is mounted in the lampshade frame.

4. The lampshade of claim 1 wherein the elliptical shape is circular.

5. A lampshade for an electric lamp comprising:
a lampshade frame having a polygon cross section and including an upper flange, a lower flange and a plurality of middle flanges extending between the upper and lower flange, a plurality of windows being formed by the upper flange, lower flange and middle flanges;
a plurality of projections extending inwardly from the lampshade frame;
a shade dimensioned to fit within the lamp shade frame and having apertures dimensioned to snuggly receive each of the plurality of projections, the apertures being positioned such that the shade fits within the lampshade frame and covers the plurality of windows when the apertures are mounted on the projections;
a plurality of covers configured to releasably attach to the plurality of projections when the shade is mounted on the projections and to thereby capture the shade on the projections within the lampshade frame; and
a spider having a plurality of arms releasably attached to the inside of the lampshade frame and having a hub attached to the arms, the hub being configured for mounting the lampshade on the electric lamp; and
the covers and the spider being configured for easy removal from the lampshade frame so that the shade can be easily removed and replaced with another shade of the same dimensions and configuration.

6. A lampshade for an electric lamp comprising:
a lampshade frame including an upper flange, a lower flange and a plurality of middle flanges extending between the upper and lower elliptical flange, a plurality of windows being formed by the upper flange, lower flange and middle flanges;
a plurality of fasteners;
a shade dimensioned to fit on the lamp shade frame and being configured to releasably engage the fasteners to mount the shade on the frame, the fasteners being positioned such that the shade fits on the lampshade frame and covers the plurality of windows;
a spider having a plurality of arms attached to the lampshade frame and having a hub attached to the arms, the hub being configured for mounting the lampshade on the electric lamp; and
the shade and fasteners being configured so that the shade can be easily removed and replaced with another shade of the same dimensions and configuration.

7. The lampshade of claim 6 wherein the fasteners are configured to mount the shade and the spider on the frame.
